(19) United States
(12) Patent Application Publication
(10) Pub. No.: US 2005/0053719 A1
(43) Pub. Date: Mar. 10, 2005

(54) Method of manufacturing luminescence device, and luminescence device

(75) Inventor: Kohei Ishida, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/895,340

(22) Filed: Jul. 21, 2004

(30) Foreign Application Priority Data
Jul. 28, 2003 (JP) 2003-202583

(51) Int. Cl. H05B 33/10

(52) U.S. Cl. 427/66; 347/195; 428/917

(57) ABSTRACT

Aspects of the invention provide a method of manufacturing a luminescence device including forming the first electrode on a substrate, forming a function layer including a luminescence layer on the first electrode, forming a second electrode on the function layer, and forming a sealing layer that covers a luminescence portion, formed of the first electrode, the function layer, and the second electrode, and the sealing layer is formed by an ink-jet method. Accordingly, the deterioration of a luminescence device that is sealed with the sealing layer can be prevented for a long period of time by an inexpensive method.

### BACKGROUND OF THE INVENTION

1. Field of Invention

The invention relates to a method of manufacturing a luminescence device, and in particular to a technology of sealing a substrate of the luminescence device.

2. Description of Related Art

In recent years, development of an organic electro-luminescence device (a luminescence device with a structure having a luminescence layer, made of organic material, between an anode and a cathode) as a self-luminescence type display in place of a liquid crystal display has been progressing rapidly. As for a structure of an organic electro-luminescence device, for example, a stacked structure, where an anode formed of a transparent electrode, a positive hole injection/transportation layer, a luminescence layer formed of organic material, and a cathode having no optical transparency are formed on a transparent substrate in this order, is cited. In the organic electro-luminescence device with this stacked structure, light produced by the combination of electrons and holes in the luminescence layer is radiated to the substrate side. Moreover, there is also a structure of the organic electro-luminescence device, in which an electrode at the substrate side (anode) is opaque and a cathode is transparent. In this case, the luminescence by the organic electro-luminescence device can be obtained at the cathode side. Furthermore, another example of a structure of the organic electro-luminescence device, in which a substrate is a transparent substrate such as a glass substrate and both electrodes are transparent, is cited. In this case, the luminescence by the organic electro-luminescence device is obtained at the substrate side and at the cathode side.

The characteristics of the organic electro-luminescence device reside in that the luminescence is generated in high intensity and in high efficiency by just applying a low voltage. However, as for the organic electro-luminescence device, there is a problem that these excellent characteristics is not obtained as structure members of the device deteriorate due to the variation with time, and in particular the deterioration of the luminescence characteristic with time is significant. A deterioration factor thereof is that the cathode and the luminescence layer made of organic material, in particular, are oxidized by oxygen and moisture in the atmosphere, thereby causing the deterioration of the luminescence intensity. As for a countermeasure thereof, for example, Japanese laid-open patent publication No. H5-182759 proposes a method of preventing the deterioration with time by forming an optically-cured resin layer having a moisture resistance on a glass substrate so as to cover an EL layer, made of organic substance, and by fixing a non water-permeable glass substrate onto the optically-cured resin layer. Moreover, Japanese laid-open patent publication No. H5-36475 proposes a method that after having provided a protective layer formed of a high molecular compound having electrical insulating property, providing a shield layer, made of one material selected from a group of an electric insulation glass, a polymer compound having electrical insulating property, and an film having electrical insulating property, to the outside of the protective layer. Furthermore, Japanese Patent Publication No. 2686169 proposes a method of improving the moisture resistance by adhering a seal plate, which covers a first electrode and a second electrode, a first insulating layer and a second insulating layer, and a luminescence layer, onto a substrate in a thin film EL panel, providing a groove portion having an opening portion toward the substrate side on the periphery portion of inside of the adhesion portion of the seal plate, and embedding moisture absorbing material in the above-described groove portion.

### SUMMARY OF THE INVENTION

According to these methods, it is assumed that progress of the deterioration of the organic electro-luminescence device can be suppressed significantly, and a longer life span can be attained. As for the method of covering the anode, the function layer including the luminescence layer, and the cathode with optically-cured resin material, there are methods, such as a spin coating method, a dipping method, and a dripping method by a dispenser. However, in these methods, the resin material is remarkably wasted, thereby causing a big problem in reducing the manufacturing cost. Moreover, Japanese laid-open patent publication No. H5-36475 proposes a method of covering with a protective layer, made of a high molecular compound with electrical insulating property, such as a vacuum deposition method, a sputtering method, a CVD method, however, for example, in the sputtering method, damage is given to the luminescence layer, and thus the luminescence characteristic deteriorates. Also, in the CVD method, the time required for forming the protective layer needs to be long, and furthermore, the high molecular compound material is wasted remarkably. Therefore, these are serious obstacles for the improvement in quality, the improvement in productivity, and for the reduction of the manufacturing cost. Furthermore, in the case that moisture absorbing material is embedded on the periphery portion of inside of the seal plate, there is a problem that the moisture absorption effect is limited to this periphery portion.

Aspects of the invention can provide a method of manufacturing a luminescence device, which is excellent in moisture resistance without causing adverse influences on the-organic material and which can improve significantly the yield at the time of manufacturing and the reduction of productivity cost, and to provide the luminescence device.

An exemplary luminescence device according to the invention can include at least a first electrode, a function layer including a luminescence layer, and a second electrode on a substrate. A method of manufacturing the luminescence device can include forming the first electrode on the substrate, forming a function layer on the first electrode; forming the second electrode on the function layer, and forming a sealing layer that covers a luminescence portion, formed of the first electrode, the function layer, and the second electrode. The sealing layer can be formed by an ink-jet method.

According to such method of manufacturing the luminescence device, because the sealing layer that covers the luminescence portion, formed of the first electrode, the function layer, and the second the electrode, is formed by applying the sealing layer forming material by an ink-jet method, it is possible to apply only to the sealing layer formation region with higher precision as compared with a method of applying by a spin coating method, for example, thereby producing no waste for the sealing layer forming material.

According to the invention, it can be preferable that the sealing layer includes an organic layer, made of resin material, and an inorganic layer, made of metal oxide or metal nitride. As for such structure, because the organic layer can prevent moisture, and the inorganic layer can remove gaseous molecules such as oxygen molecule or water molecule by having them react and combine with the metal oxide or with the metal nitride, the deterioration of the luminescence portion by oxidization can be prevented. The organic layer forming material includes UV-cured resin such as acrylic resin and epoxy resin, or thermosetting resin. Among these, epoxy resin is particularly preferable because the moisture resistance is high and the transmissivity of visible light is also high. The organic layer can be easily formed by curing, after applying, for example, liquid thermosetting epoxy resin or liquid optically-cured epoxy resin by an ink-jet method. The inorganic layer forming material includes metal oxide such as silicon oxide (SiO₂ or SiO), magnesium oxide (MgO), calcium oxide (CaO), aluminum silicate (AlOSiO₄), and potassium pyrophosphate (K₄P₂O₇), or metal nitride such as silicon nitride (Si₃N₄), aluminum nitride (AlN), titanium nitride (TiN), and boron nitride (BN). The inorganic layer can be formed by applying fluid of these metal oxides or metal nitrides, mixed with a solvent, by an ink-jet method.

According to the invention, it is preferable that a plurality of layers of the organic layer and the inorganic layer are stacked alternately and the lowest layer thereof is the organic layer. According to such manufacturing method, stacking a plurality of layers can be implemented quite easily by applying the organic layer forming material with an ink-jet method at first, and then, applying alternately the inorganic layer forming material and the organic layer forming material by an ink-jet method. Moreover, because the material can be applied only to the organic layer formation region and the inorganic layer formation region precisely, no waste is produced for the material. Furthermore, by stacking a plurality of layers of the organic layer and the inorganic layer, a plurality of barrier layers are provided, and thus the oxidization by moisture or oxygen can be prevented. Moreover, the thickness of each of the organic layer and the inorganic layer can be made thin because a plurality of layers are stacked alternately, thus flexibility can be given to the sealing layer. In this case, when making the substrate with a plastic film, an organic electro-luminescence device with flexibility can be realized. Moreover, when making the lowest layer with the inorganic layer, made of metal oxide or metal nitride, there is a concern that a second electrode in contact with the metal oxide or with the metal nitride is oxidized. Therefore, it is preferable that the lowest layer is an organic layer, made of resin material. In particular, by making the lowest layer with an organic layer, it is possible to use a thin film having a low work function, such as aluminum (Al), magnesium (Mg), and calcium (Ca) for the second electrode, and thus a structure of the organic electro-luminescence device, wherein the luminescence is taken out not only to the substrate side but to the sealing layer side, can be realized.

According to an aspect of the invention, it is preferable that a non water-permeable sealing member is fixed to the surface of the sealing layer, which is at the opposite side of the substrate side. According to such manufacturing method, with the non water-permeable sealing member being placed on the surface of the organic layer or the inorganic layer of the sealing layer that is formed at the opposite side of the substrate side, the organic layer forming material or the inorganic layer forming material is cured and fixed. Thus, the area of the surface of the sealing layer, which contacts with the atmosphere, decreases by the amount of the area of the sealing member. For this reason, it is more difficult for oxygen and moisture to permeate, and the deterioration of the luminescence intensity can be prevented furthermore. As for the non water-permeable sealing member, a glass plate, an acrylic plate, a plastic film, an aluminum metal plate, and a stainless steel plate are exemplified, and the glass plate having a high optical transmissivity is particularly preferable. This is because the light produced by the combination of electrons and holes in the luminescence layer can be taken out also from the sealing layer side. In this case, the sealing member is preferably of plate shape, and furthermore, the sealing member has a function as a protection member of the surface of the sealing layer. Consequently, structures of the luminescence device of not only the bottom emission type that takes out luminescence from the substrate side but also the top emission type luminescence device that takes out luminescence from the sealing layer side can be realized, and a structure of the luminescence device, in which the luminescence is taken out from both the substrate side and the sealing layer side, can be also realized.

According to an aspect of the invention, it can be preferable that the surface of the sealing layer, which is at the opposite side of the substrate side, is formed flatly and smoothly. According to such manufacturing method, because the sealing layer and the non water-permeable sealing member are stuck firmly, it is difficult for moisture and oxygen to permeate the boundary surface of the sealing layer and the non water-permeable sealing member. As a result, it is difficult for the luminescence portion to be oxidized and the deterioration of the luminescence intensity can be prevented furthermore. Moreover, by using an ink-jet method, it can be easily realized to apply the sealing layer forming material so as to make the surface of the sealing layer flat and smooth, because the applying amount can be partially increased and decreased as will be described later. Furthermore, before placing the sealing member on the surface of the sealing layer, which is at the opposite side of the substrate side, the surface of the sealing layer is mechanically ground to be flat and smooth and an adhesive, made of moisture-resistant resin material, is applied thereon, and subsequently the sealing member may be placed to be fixed.

According to an aspect of the invention, it is preferable that elevation differences in layer thickness of the sealing layer exist due to an unevenness shape in the sealing layer formation region, on the substrate. According to such manufacturing method, to cope with the level differences of the unevenness shape of the luminescence portion, formed of the first electrode, the function layer, and the second electrode, and formed in the sealing layer formation region, on the substrate, an applying method by an ink-jet device is adjusted. For example, the discharge amount is adjusted based on the discharging position, or the discharging pitch is adjusted for each discharging position, so as to discharge while adjusting the thickness of the sealing layer for each discharging position. Therefore, the surface can be made flat and smooth by discharging large amount at a concave-shaped portion and discharging small amount at a convex-shaped portion. As a result, the flat sealing member, such as glass to be placed on the sealing layer, and the sealing layer can be stuck firmly. With an ink-jet method, it can be easily realized to form the sealing layer having a flat and smooth surface by partially changing the thickness in such a way. In the case that the thickness of the sealing layer is changed partially, it is preferable to carry out in the step of applying the organic layer, made of resin material. The reason is because there is a concern that increased thickness may reduce the transmissivity of visible light depending on the type of the metal oxide or the metal nitride of the inorganic layer when the thickness of the inorganic layer is changed.

According to aspects of the invention, a sealing portion, made of resin material, having a cyclic monomers can be formed by an ink-jet method in the periphery portion of the surface, where the first electrode of the substrate is formed, and in the outside of the sealing layer formation region. And the sealing portion is cured with the non water-permeable sealing member being placed on the upper surface of the sealing portion.

With such manufacturing method, the sealing portion, made of resin material, having a cyclic monomers can be formed in the periphery portion of the substrate by an ink-jet method precisely and easily. Furthermore, because the luminescence portion can be sealed with the non water-permeable sealing member, the sealing portion made of resin material having a moisture resistance, and the substrate, the luminescence portion is shielded from oxygen and moisture in the atmosphere, and it is difficult for the luminescence portion to be oxidized, and thus the luminescence device, whose luminescence intensity does not easily deteriorate, can be provided. As for the non water-permeable sealing member, a glass plate, an acrylic plate, a plastic film, an aluminum metal plate, and a stainless steel plate are exemplified, and the glass plate having a high optical transmissivity is particularly preferable. This is because the light produced by the combination of electrons and holes in the luminescence layer can be taken out also from the sealing layer side. Furthermore, the shape of the sealing member may be not only of plate type but also of box type, whose surface at the substrate side is opened. In this case, when an aluminum metal plate is used, a bottom emission type luminescence device, in which the luminescence is taken out to the substrate side, is made. As for the sealing portion forming resin material, UV-cured resin such as acrylic resin and epoxy resin, or thermosetting resin are exemplified, and the epoxy resin is particularly preferable because it has not only moisture resistance but an adhesion function.

According to aspects of the invention, a plurality of the luminescence devices are concurrently formed on one substrate base material, and the substrate base material is diced per each luminescence device.

According to such manufacturing method, when forming a plurality of luminescence devices on the substrate base material, because the sealing layer forming material and the resin material can be applied precisely only to the sealing layer formation region, and/or to the sealing portion formation region of each luminescence device, less waste is produced for the sealing layer forming material and the resin material that are used as compared with, for example, a spin coating method, in which the sealing layer forming material and the resin material are applied on the whole surface of the substrate base material. Furthermore, in the case of a spin coating method, the step of removing the sealing layer forming material and the resin material, applied to the regions other than the formation region, is required, however, this step is also unnecessary for the above method, so that the productivity becomes high. Next, dicing of each of the plurality of luminescence devices, which are formed on the substrate base material, is carried out by the following method. For example, in the case of a glass substrate, a scribe line having a cross section with a V-shaped groove portion is formed in advance on the surface of the glass substrate base material, and with the leading edge of a blade-shaped tool being forced to the groove portion of the scribe line, vibration is applied to the tool for cutting, or a tool called a squeegee is dropped from above to the surface, which is the opposite side of the scribe line, while targeting at the scribe line, and the cutting is performed by this impact. The substrate base material is not limited to the glass substrate but may be a plastic film.

Next, the luminescence device according to the invention is obtained by the above-described manufacturing method. According to such luminescence device, because it is difficult for the second electrode and the function layer to be oxidized with oxygen and moisture in the atmosphere, a luminescence device, whose luminescence intensity does not easily deteriorate due to variation with time, and which is long lasting and less costly, can be provided.

### BRIEF DESCRIPTION OF THE DRAWINGS

The invention will be described with reference to the accompanying drawings, wherein like numerals reference like elements, and wherein:

FIG. 1 is a view showing a structure of a first exemplary embodiment of an organic electro-luminescence device according to the invention, and is a cross-sectional view corresponding to a cross section along the A-A line of FIG. 3;

FIG. 2 is a cross-sectional view showing each step of a method of manufacturing the organic electro-luminescence device of FIG. 1;

FIG. 3 is a plan view showing one condition of the manufacturing process of the organic electro-luminescence device of FIG. 1, and shows the condition of FIG. 2(a);

FIG. 4 is a process view explaining a method of manufacturing the organic electro-luminescence device of the first embodiment of the invention;

FIG. 5 is a view showing a structure of a second embodiment of the organic electro-luminescence device according to the present invention, and is a cross-sectional view corresponding to a cross section along the A-A line of FIG. 7;

FIG. 6 is a cross-sectional view showing each step of the method of manufacturing the organic electro-luminescence device of FIG. 5;

FIG. 7 is a plan view showing one condition of the manufacturing process of the organic electro-luminescence device of FIG. 5, and shows the condition of FIG. 6(a);

FIG. 8 is a plan view showing a head that is used for the manufacture of the organic electro-luminescence device of the invention;

FIG. 9 is a plan view showing an ink-jet device that is used for the manufacturing of the organic electro-luminescence device according to the invention;

FIG. 10 is a cross-sectional view showing a structure of an organic electro-luminescence device of top emission type; and

FIG. 11 is a perspective view showing an example of electronic equipment according to the present invention.

### DETAILED DESCRIPTION OF PREFERRED EMBODIMENTS

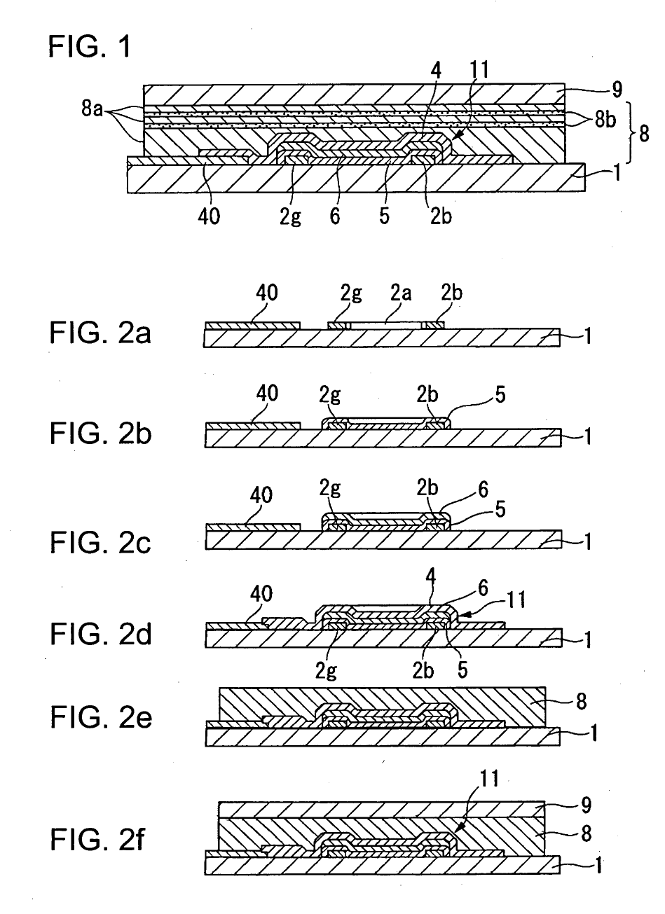

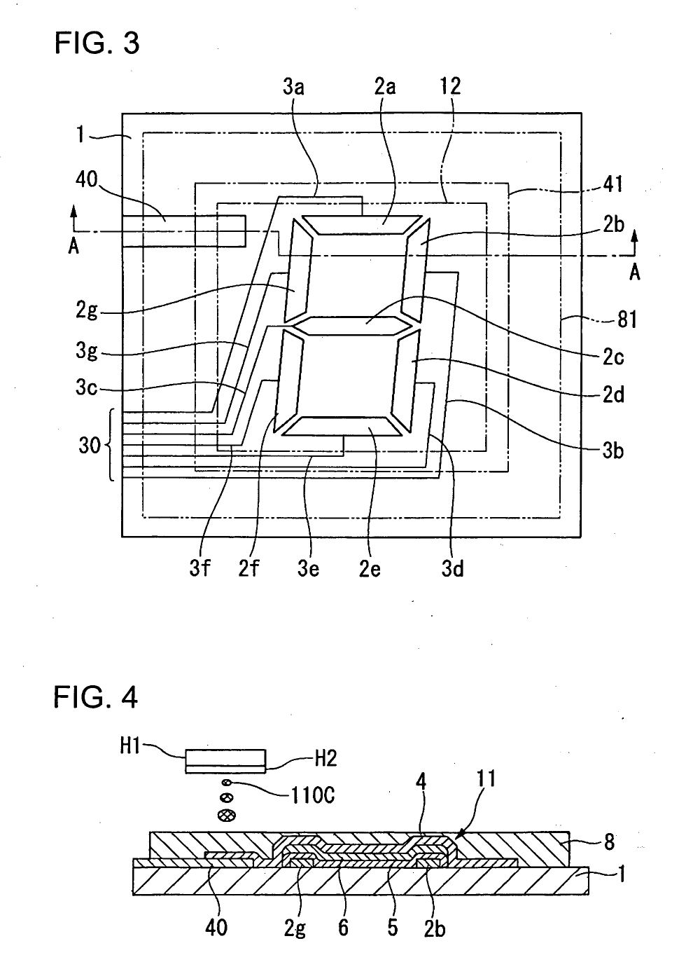

Hereinafter, exemplary embodiments according to the invention will be described with reference to drawings. A first exemplary embodiment of an organic electro-luminescence device, which is one example of a luminescence device according to the present invention, will be described by referring to FIGS. 1 through 3. FIG. 1 is a view showing a structure of the organic electro-luminescence device, and is a cross-sectional view corresponding to a cross section along the A-A line of FIG. 3. FIG. 2 is a cross-sectional view showing each step of a method of manufacturing the organic electro-luminescence device. FIG. 3 is a plan view showing one condition of the manufacturing process of the organic electro-luminescence device, and shows the condition of FIG. 2(a).

The organic electro-luminescence device of the exemplary embodiment can include seven elements, which constitute a digital number, as a luminescence portion formed of organic electro-luminescence elements. The organic electro-luminescence device is a display unit, which displays digital numbers or the like by having either of the elements radiate, as required. The region inside a reference numeral 12 of FIG. 3 corresponds to the display region of the organic electro-luminescence device.

As shown in FIG. 1 and FIG. 3, an organic electro-luminescence device of the embodiment can include a transparent glass substrate 1, transparent anodes (anode layers) 2a through 2g corresponding to the seven elements, electric wirings 3a through 3g for each of the anodes 2a through 2g, a transparent cathode layer 4, a terminal 40 for a cathode, a positive hole transportation layer 5, an organic luminescence layer 6, a sealing layer 8 formed of an organic layer 8a and an inorganic layer 8b, and a glass plate (sealing member for protection) 9. The region inside a reference numeral 81 of FIG. 3 is the formation region of the sealing layer 8.

Namely, the organic electro-luminescence device is a transparent organic electro-luminescence device, and a luminescence portion (a luminescence portion having a function layer, formed of the positive hole transportation layer 5 and the organic electro-luminescence layer 6, between the anode layers 2a through 2g and the cathode layer 4) 11, forming the organic electro-luminescence element is formed on the glass substrate. The sealing layer 8, made of the transparent sealing layer forming material, is formed on the surface at a counter substrate side of the luminescence portion 11 (at the opposite side of the substrate side) by an ink-jet method, and the sealing member (glass plate) 9 is fixed to the surface of the counter substrate side of the sealing layer 8. As shown in FIG. 1, the sealing layer 8 is formed of the organic layer 8a and the inorganic layer 8b. A plurality of the organic layers 8a and the inorganic layers 8b are stacked alternately, and in FIG. 1, a five-layer structure, where the lowest layer is the organic layer 8a, is shown. By covering the luminescence portion 11, which includes the cathode, with the sealing layer 8 formed of the organic layer 8a and the inorganic layer 8b, moisture and oxygen, which penetrate from the portion in contact with the atmosphere, are blocked so as not to cause an adverse influence on the luminescence portion 11. In addition, the sealing layer 8 used here also has a function to bond the glass substrate 1 and the sealing member 9. Moreover, the sealing layer 8 is formed by stacking a plurality of layers of the organic layer 8a and the inorganic layer 8b alternately, the sealing layer 8 may be formed with at least two layers or more.

As shown in FIG. 3, the cathode terminal 40 can be formed, in a band shape with a predetermined width, at one portion in cyclic monomers the substrate surface so as to reach the end portion of the substrate surface. Moreover, as shown in FIG. 3, one end of each of the electric wirings 3a through 3g is coupled to each of the anodes 2a through 2g, and the other terminals of all electric wirings 3a through 3g are arranged together in parallel with a fixed spacing, in the position aligned with the cathode terminal 40 in cyclic monomers the substrate surface. The periphery portions (the other ends) of the electric wirings 3a through 3g in the substrate surface are used as the terminals for each of the anodes 2a through 2g.

In FIG. 3, the terminals for each of the anodes 2a through 2g are denoted together as a reference numeral 30. Moreover, in FIG. 1 and FIG. 2, the electric wirings 3a through 3g are not shown. As for the organic electro-luminescence device, the whole surface of the glass substrate 1 is covered with the sealing layer 8 and the glass plate 9, while leaving the end portions, in which the terminal 30 and the terminal 40 are formed. In FIG. 2(e) and (f), the organic layer 8a and the inorganic layer 8b are omitted and illustrated as the sealing layer 8. The organic electro-luminescence device is used by coupling the electric wirings from a driving circuit between the anode terminal 30 and the cathode terminal 40 that are exposed.

The glass substrate 1 is made of soda glass and can have a thickness of 0.7 mm. Each of the anodes 2a through 2g, each of the electric wirings 3a through 3g, and the cathode terminal 40 are made of an ITO (Indium Tin Oxide) thin film and can have a thickness of 150 nm. The transparent cathode layer 4 is made of an alloy film of magnesium and silver. The cathode layer 4 is formed inside the region (the region, which includes the display region 12), which is encircled by a two-dot chain line 41 of FIG. 3.

The positive hole transportation layer 5 is formed of N, N′-Diphenyl-N,N′-dinaphthyl-1,1′-biphenyl-4,4′-diamine thin film with a thickness of 50 nm. The organic luminescence layer 6 is a thin film, made of tris (8-hydroxyquinoline) aluminum complex with a thickness of 50 nm. The positive hole transportation layer 5 and the organic luminescence layer 6 are formed in the central portion, which includes all the anodes 2a through 2g. The sealing layer 8, which is formed of the organic layer 8a, made of epoxy resin (synthetic resin), and the inorganic layer 8b, made of metal oxide such as silicon oxide, is formed with a total thickness of 30 μm. The glass plate (sealing member) 9 is made of soda glass with a thickness of 0.1 mm. The organic electro-luminescence device can be formed as follows, for example.

At first, an ITO (Indium Tin Oxide) thin film is formed on the transparent glass substrate 1 by a sputtering method, and by performing photolithography and etching to the thin film, the anodes (anode layers) 2a through 2g, the electric wirings 3a through 3g for each of the anodes 2a through 2g, and the cathode terminal 40 are formed in the substrate surface. FIG. 2(a) and FIG. 3 show this condition.

Next, the positive hole transportation layer 5 can be formed only in the central portion that includes all the anodes 2a through 2g on the glass substrate 1 by a vacuum deposition method. FIG. 2(b) shows this condition. Next, the organic luminescence layer 6 is formed only on the whole top surface of the positive hole transportation layer 5 by a vacuum deposition method. FIG. 2(c) shows this condition. In addition, in case that the organic luminescence layer is formed using polymeric material, an ink-jet method may be used.

Next, on the glass substrate 1, a thin film, made of an alloy of magnesium and silver, is formed as the cathode layer 4 by a vacuum deposition method so as to cover the region including the whole top surface of the organic luminescence layer 6 and a part of the cathode terminal 40 (the region encircled with the two-dot chain line 41 of FIG. 3). Accordingly, the luminescence portion 11, made of the organic luminescence layers of a transmission-type, is formed on the glass substrate 1. FIG. 2(d) shows this condition.

Next, in the regions, excluding the end portions where the terminal 30 and the terminal 40 are formed, on the glass substrate 1 (the region encircled with a two-dot chain line 81 of FIG. 3), resin material of epoxy resin for the organic layer 8a, and a silicon oxide, which is metal oxide for the inorganic layer 8b, are applied to stack alternately by an ink-jet device and the sealing layer 8 having a flat and smooth surface is formed. FIG. 2(e) shows this condition. Next, with the glass plate 9 being placed thereon, the sealing layer 8 is cured to fix the glass plate 9 to the sealing layer 8. FIG. 2(f) shows this condition. Preferably, the steps of FIG. 2(e) and (f) are carried out under an inert gas atmosphere, such as nitrogen atmosphere and argon atmosphere. Moreover, it is necessary to prevent the substrate from being contacted with air during the time after forming the cathode 4 and before applying the resin material of epoxy resin, which forms the organic layer 8a.

With respect to the step of forming the sealing layer 8, as shown in FIG. 1, in the case that the sealing layer 8 is formed of five layers, for example, the thickness of the organic layer 8a of the lowest layer is changed by changing the discharge amount of the resin material from an ink-jet head depending on the position in response to the unevenness conditions of the surface of the luminescence portion 11, so that the surface is made flat and smooth. Thus, the sealing layer 8, formed of a plurality of layers, is formed by discharging droplet alternately for the inorganic layer 8b and for the organic layer 8a, while having the thickness thereof make in a predetermined thickness. Next, with the sealing member (glass plate) 9 being placed on the surface of the sealing layer 8, the surface of which is made flat and smooth, the sealing layer 8 is cured to fix the sealing member 9 to the sealing layer 8. This is performed in order to stick firmly the sealing member 9 with a plate shape to the surface of the sealing layer 8. Moreover, although not shown in the drawing, for the case that the surface of the sealing layer 8 is in unevenness conditions, the sealing layer 8 and the sealing member 9 may be fixed after curing the sealing layer 8 before placing the sealing member 9, grinding the surface of the cured sealing layer 8 flatly and smoothly, applying an adhesive of epoxy type having a moisture resistance thereon and placing the sealing member 9.

A method of manufacturing the sealing layer 8 by the ink-jet device is as follows. As shown in FIG. 4, an epoxy resin material composition 110C with a moisture resistance, which forms the organic layer 8a, is discharged from a plurality of nozzles formed in an ink-jet head H1. The composition 110C is discharged to fill in the sealing layer formation region, on or above the glass substrate 1 and the cathode layer 4 by scanning the ink-jet head, however, the composition 110C can be also discharged to fill in the region by scanning the glass substrate 1. Furthermore, the composition 110C can be discharged to fill in the region by relatively shifting the ink-jet head H1 and the glass substrate 1. In the subsequent steps of carrying out using the ink-jet head H1, the above-described aspects are the same.

The discharge by the ink-jet head H1 can be carried out as follows. Namely, a discharge nozzle H2, formed in the ink-jet head H1, is arranged opposing to the sealing layer formation region, on or above the glass substrate 1 and the cathode layer 4, and the epoxy resin material droplet 110C, which forms the organic layer 8a, is discharged from the discharge nozzle H2. Having the ink-jet head H1 oppose to the sealing layer formation region, while relatively shifting the ink-jet head H1 and the glass substrate 1, the epoxy resin material droplet 110C, whose volume per one droplet is controlled, is discharged from the discharge nozzle H2 to the sealing layer formation region, on or above the glass substrate and the cathode layer. As for the resin material droplet 110C used here, thermosetting epoxy resin, for example, is preferable because it has the transparency and function as adhesiveness as well as a moisture resistance.

Next, the discharge nozzle H2, formed in the ink-jet head H1, is arranged opposing to the sealing layer formation region, on or above the glass substrate 1 and the cathode layer 4, and the droplet, made of fluid of metal oxide such as silicon oxide mixed with a solvent, which forms-the inorganic layer 8b, is discharged on the organic layer, and thus the inorganic layer 8b is formed. Subsequently, the sealing layer 8, formed of a plurality of layers, is formed while alternately discharging and stacking the droplet, which forms the organic layer and the inorganic layer. As a result, the sealing layer 8, in which a plurality of layers of the organic layer 8a made of epoxy resin with a moisture resistance or the like, and the inorganic layer 8b made of, for example, silicon oxide, which can remove gaseous molecules such as oxygen molecule or water molecule by reacting and combining with metal oxide or metal nitride, are stacked alternately, is formed. Here, the lowest layer of the sealing layer 8 is preferably the organic layer 8a. The reason is because when the lowest layer is an inorganic layer made of metal oxide or metal nitride, there is a concern that a second electrode, contacting the metal oxide or the metal nitride, is oxidized. Therefore, it is preferable that the lowest layer is made as the organic layer 8a made of resin material. In particular, by making the lowest layer as the organic layer 8a, a thin film with a low work function such as aluminum (Al), magnesium (Mg), and calcium (Ca) can be used for the second electrode, and thus a configuration of the organic electro-luminescence device, wherein the radiation is taken out not only to the substrate side but to the sealing layer side, can be realized.

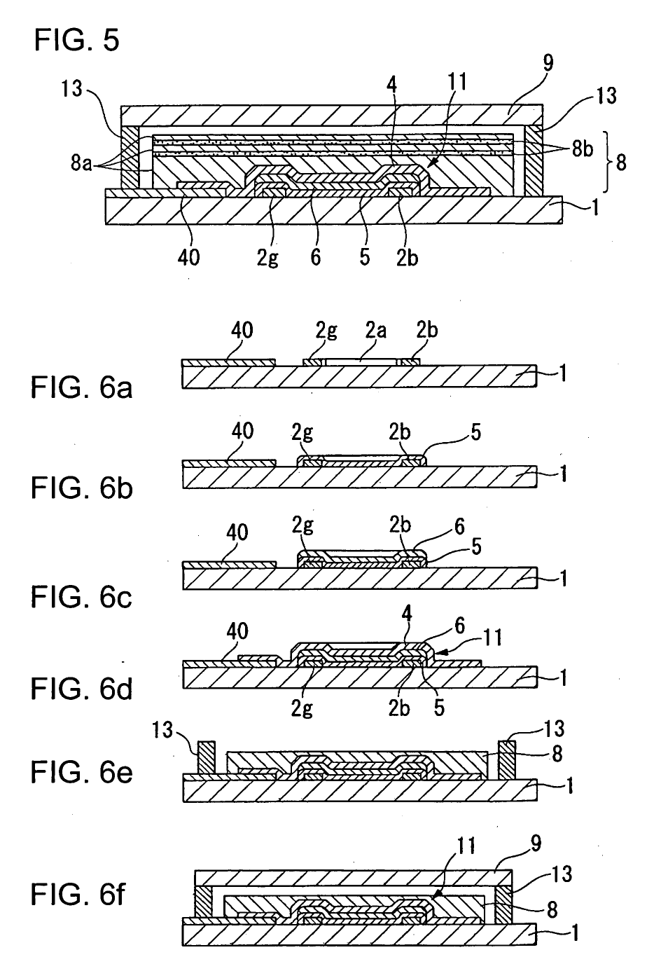

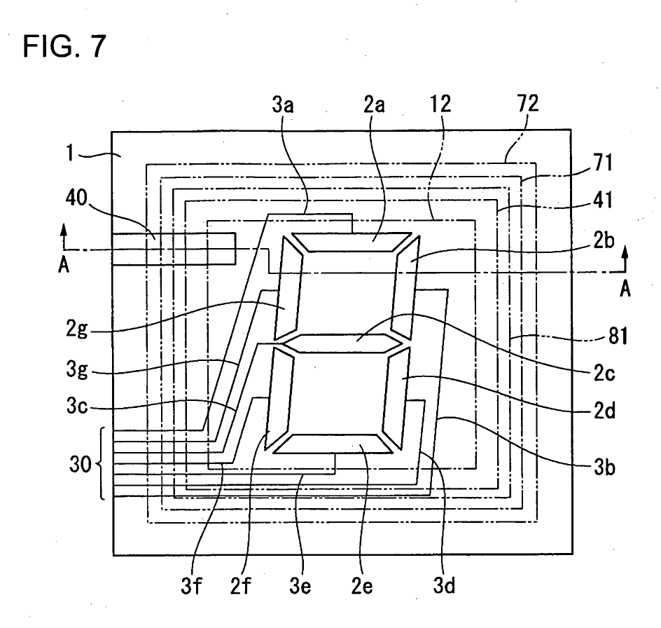

Next, a second exemplary embodiment of the organic electro-luminescence device according to the invention will be described by referring to FIG. 5, FIG. 6, and FIG. 7. FIG. 5 is a view showing a second exemplary embodiment of the organic electro-luminescence device according to the invention. FIG. 5 is a view showing a structure of the organic electro-luminescence device, and is the cross-sectional view corresponding to a cross section along the A-A line of FIG. 7. FIG. 6 is a cross-sectional view showing each step of a method of manufacturing the organic electro-luminescence device. FIG. 7 is a plan view showing one condition of the manufacturing process of the organic electro-luminescence device, and shows the condition of FIG. 6(a). In FIG. 6(e) and (f), the organic layer 8a and the inorganic layer 8b are omitted and illustrated as the sealing layer 8. In the second embodiment, a sealing portion 13, made of resin material, is formed in a cyclic monomers (the region encircled with two-dot chain lines 71 and 72 of FIG. 7) in the region, excluding the end portions where the terminal 30 and the terminal 40 are formed, on the glass substrate 1, by applying epoxy resin material by an ink-jet method. Then, the epoxy resin is cured, with the sealing member (glass plate) 9 being placed on the sealing portion 13. This step is carried out under an inert gas atmosphere.

In the second exemplary embodiment, the sealing portion 13 having a cyclic monomers is formed in the periphery portion of the glass substrate 1, inside which the sealing layer 8 according to the invention is formed so as to cover the cathode layer 4. The region encircled with a two-dot chain line 81 of FIG. 7 is the formation region of the sealing layer 8. This step of forming the sealing portion is the step, wherein the sealing portion 13, made of resin material and formed by an ink-jet method, is arranged in the periphery portion of the glass substrate 1, in which the luminescence portion 11 is formed, and the sealing portion 13 is formed on the glass substrate 1, and sealing the luminescence portion 11 with the glass substrate 1, the sealing portion 13 having a cyclic monomers, and the sealing member (glass plate) 9. Moreover, the sealing portion 13 can be easily formed in a cyclic monomers only in the formation region by an ink-jet method. As for each step of the manufacturing method of the organic electro-luminescence device of the second embodiment, the steps of FIG. 6(e) and (f) differ from the steps of FIG. 2(e) and (f), however, the steps other than these are the same as the first embodiment. Namely, in the second embodiment, the step of forming the sealing portion 13 shown in FIG. 6(e) is carried out by an ink-jet method after the forming the sealing layer 8, and then the sealing member 9 shown in FIG. 6(f) is placed on top of the sealing portion 13, and the sealing member 9 is fixed to the sealing portion 13 by curing the sealing portion 13.

The method of forming the sealing layer 8 can be carried out by the same method as that of the first exemplary embodiment. Moreover, because the formation of the sealing layer 8 and the sealing portion 13 is carried out by an ink-jet method, the sealing portion 13 may be formed at first. In this case, it is preferable that the step of forming the sealing portion is carried out in an inert gas atmosphere such as nitrogen, argon, and helium. When carrying out in the atmosphere, in cases that defects such as a pinhole exist, there is a concern that moisture, oxygen or the like may penetrate from this defect portion into the cathode 4 to oxidize the cathode 4, which is therefore not preferable. Furthermore, although not shown in the drawing, after forming the sealing portion 13, the sealing layer 8 is formed, and then the space encircled by the glass substrate 1, the sealing portion 13, and the sealing member 9, may be embedded with resin material by applying and filling the resin material onto the sealing layer 8 by an ink-jet method.

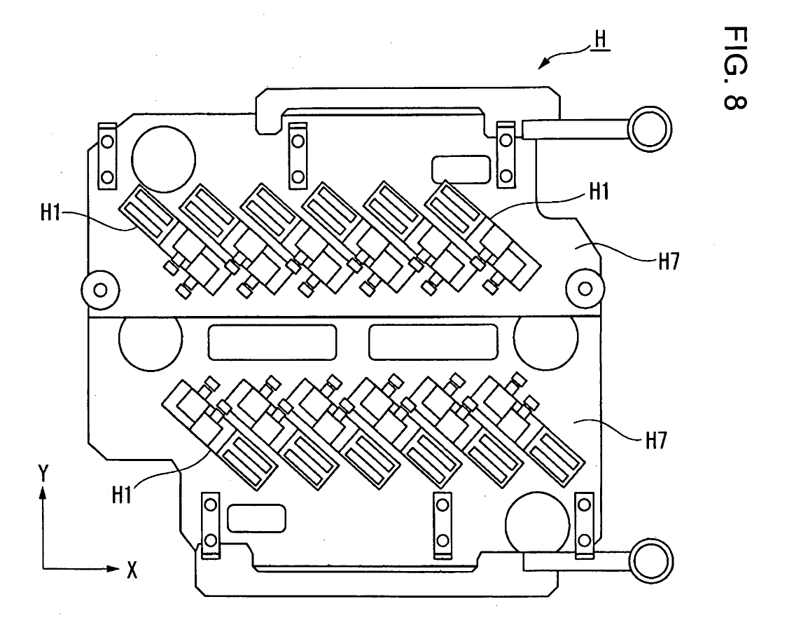

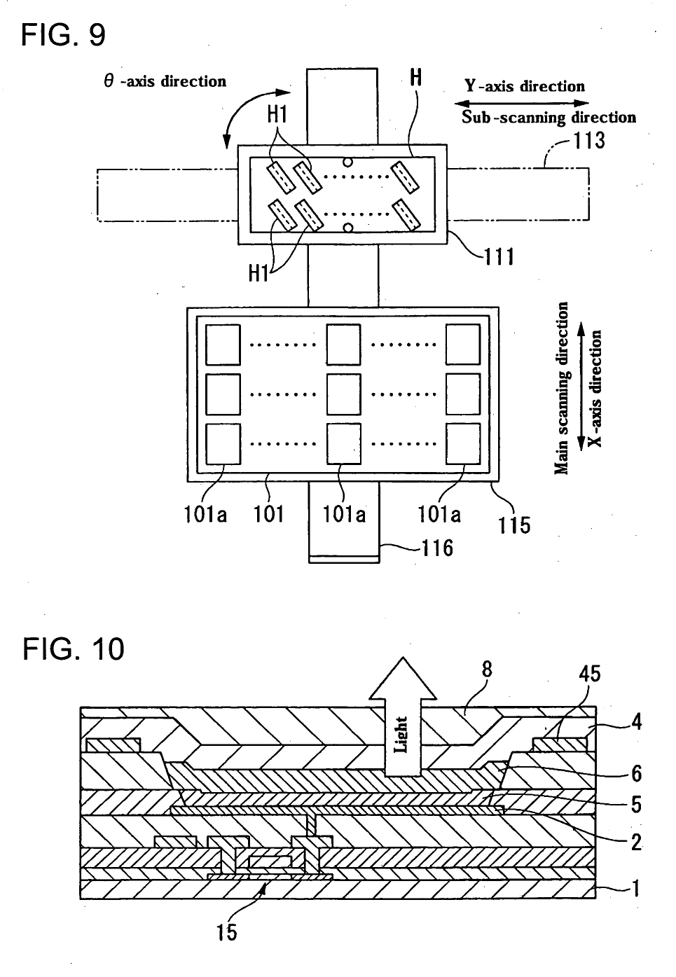

With respect to the structure of the ink-jet head, a head H shown in FIG. 8 can be employed. Furthermore, with respect to the arrangement of the substrate and the ink-jet head, the arrangement shown in FIG. 9 is preferable. In FIG. 8, a reference numeral H7 refers to a support base, which supports the above-described ink-jet head H1, and a plurality of ink-jet heads H1 are provided on the support substrate H7.

On the ink discharging surface of the ink-jet head H1 (the surface opposite to the substrate 101), a plurality of discharge nozzles (for example, 180 nozzles per one row, and a total of 360 nozzles) are provided in a row along the length direction of the head with two rows having an interval in the width direction of the head. Moreover, while the inkjet head H1 directs discharge nozzle to the substrate side 101, a plurality of the ink-jet head H1 (in FIG. 8, six nozzles per one row, and a total of 12 nozzles) are positioned and supported, at a predetermined angle inclined to the X-axis (or Y-axis), onto the support plate having a shape of substantially rectangular as viewed from the plane.

Moreover, in the ink-jet device shown in FIG. 9, a reference numeral 115 refers to a stage for mounting a substrate 101, and a reference numeral 116 refers to a guide rail for guiding a stage 115 in the X-axis direction (main scanning direction) in the drawing. Moreover, the head H is designed to be capable of shifting in the Y-axis direction (sub-scanning direction) in the drawing by a guide rail 113 via a supporting member 111. Furthermore, the head H is designed to be capable of rotating in the θ-axis direction in the drawing, and designed to be capable of inclining the ink-jet head H1 to the main scanning direction at a predetermined angle.

The substrate 101 shown in FIG. 9 has a structure, in which a plurality of chips are arranged on a motherboard. Namely, a region for one chip corresponds to one display device. Here, a plurality of display regions 101a are formed, but not limited to this. For example, when applying a composition to the display region 101a in the left row on the substrate 101, the head H is shifted to the left side in the drawing through the guide rail 113, and the substrate 101 is shifted to the upper side of the drawing through a guide rail 116, and the applying is carried out while scanning the substrate 101. Next, the head H is shifted to the right side in the drawing, and the composition is applied to the display region 101a in the central row of the substrate. The same process is also carried out to the display region 101a in the right row. In addition, the head H shown in FIG. 8 and the ink-jet device shown in FIG. 9 may be used not only for the steps of forming the sealing layer and the sealing portion but also of forming the luminescence layer.

In the ink-jet device of FIG. 9, a plurality of chips 101a are formed on the substrate base material 101. The plurality of chips 101a correspond to the glass substrate 1 in the first exemplary embodiment and the second exemplary embodiment. Each of the organic electro-luminescence devices corresponding to the chip 101a, which is manufactured in either one of the first embodiment or the second embodiment, is diced after the substrate base material 101 is removed from the ink-jet device, with the above-described scribe groove portion being as the division line. The diced chip 101a becomes each organic electro-luminescence device according to the present invention.

For the case that a plurality of organic electro-luminescence devices are formed on the substrate base material 101 of FIG. 9, when an ink-jet method is used in the steps of forming the sealing layer 8 and the sealing portion 13, no waste is produced for the material to be used, because the material can be applied only to the formation region precisely. In a spin coating method, because the material is applied to the whole surface of the substrate base material 101, the step for removing the resin material or the droplet, applied to the region where no formations should occur, is necessary. However, in an ink-jet method, this step is not necessary and thus a manufacturing method with a high productivity is realized.

Moreover, the invention can be applied also to an organic electro-luminescence device of top emission type shown in FIG. 10. Because the organic electro-luminescence device is a display device having an organic electro-luminescence element as a pixel, whose drive method is an active-matrix method, a TFT (Thin Film Transistor) 15 for each pixel is formed on the substrate 1. For each pixel, an opaque anode layer 2 is formed in contact with the TFT 15, and a positive hole transportation layer 5, a luminescence layer 6, and a transparent cathode layer 4 are sequentially formed thereon. In addition, an auxiliary cathode 45 is also formed in this example. Then, on the cathode layer 4, the sealing layer 8, in which a plurality of layers of the organic layer, made of transparent epoxy resin, and the inorganic layer, made of silicon oxide and the like, are stacked alternately, is formed. In FIG. 10, the organic layer 8a and the inorganic layer 8b are omitted and illustrated as the sealing layer 8.

In the organic electro-luminescence device, the luminescence is obtained at the opposite side of the substrate 1 (namely, at the side of the cathode layer 4). For this reason, in the organic electro-luminescence device, a semiconductor substrate such as a silicon wafer, and a substrate having a reflection characteristic can be employed as the substrate 1. Moreover, the portion above the TFT 15 on the substrate 1 can be made as a region for a luminescence pixel. As a result, as for the organic electro-luminescence device, the aperture ratio can be increased to approximately 70%. On the other hand, as for the organic electro-luminescence device of bottom emission type (a structure having a transparent substrate, a transparent electrode layer at the substrate side, and an opaque electrode layer at the opposite side of the substrate) having the conventional structure, in which the luminescence is obtained at the substrate side, the aperture ratio is approximately 30% because the portion above the TFT on the substrate can not be made as a region for the luminescence pixel. Therefore, by making an organic electro-luminescence device of top emission type, the luminescence intensity can be made higher or the power consumption can be made lower as compared with organic electro-luminescence devices having the conventional structure.

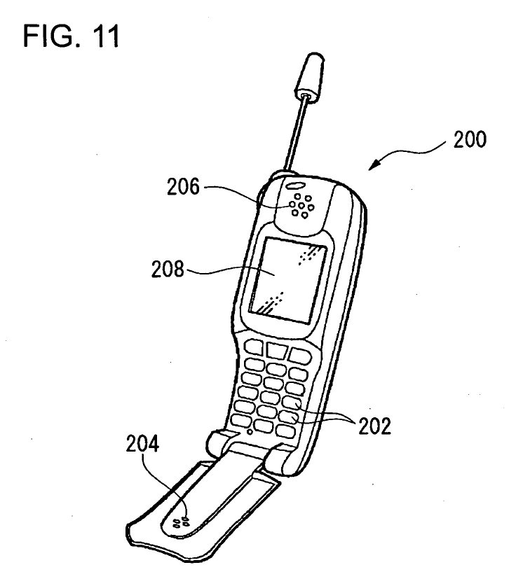

Furthermore, the organic electro-luminescence device according to the invention can be applied to various electronic equipment such as a cellular phone, a mobile type personal computer, and a digital still camera. FIG. 11 is a perspective view of a cellular phone. In FIG. 11, a cellular phone 200 includes a display panel 208, formed of an organic electro-luminescence device according to the present invention, along with an earpiece 204 and a mouthpiece 206, in addition to a plurality of operation buttons 202.

Other than the cellular phone of FIG. 11, electronic equipment, to which the organic electro-luminescence device according to the present invention can be applied as a display, includes a personal computer, a digital still camera, a television, a video tape recorder of view finder type or of monitor direct view type, a car navigation unit, a pager, an electronic organizer, a pocket calculator, a word processor, a workstation, a TV phone, a POS terminal, and apparatus equipped with a touch panel or the like.

As described above, the preferred exemplary embodiments according to the invention have been described with reference to the accompanying drawings, however, the invention is not limited to these embodiments but can be implemented by modifying the embodiments, as required, within the spirit and scope of the invention.

1. A method of manufacturing a luminescence device having at least a first electrode, a function layer including a luminescence layer, and a second electrode on a substrate, the method comprising:
forming the first electrode on the substrate;
forming the function layer on the first electrode;
forming the second electrode on the function layer; and
forming a sealing layer that covers a luminescence portion, formed of the first electrode, the function layer, and the second electrode, the sealing layer being formed by an ink-jet method.

2. The method of manufacturing the luminescence device according to claim 1, the sealing layer further including an organic layer made of resin material and an inorganic layer made of metal oxide or metal nitride.

3. The method of manufacturing the luminescence device according to claim 2, the sealing layer including of a plurality of layers of the organic layer and the inorganic layer which are alternately stacked, and a lowest layer of the sealing layer being the organic layer.

4. The method of manufacturing the luminescence device according to claim 1, a non water-permeable sealing member being fixed to a surface of the sealing layer, which is at an opposite side of the substrate side.

5. The method of manufacturing an organic electro-luminescence device according to claim 1, a surface of the sealing layer, which is at an opposite side of a substrate side, being formed flat and smooth.

6. The method of manufacturing the luminescence device according to claim 5, elevation differences in layer thickness of the sealing layer existing due to an unevenness shape in a sealing layer formation region, on the substrate.

7. The method of manufacturing the luminescence device according to claim 1, a sealing portion made of resin material having cyclic monomers being formed by an ink-jet method in a periphery portion of a surface of the substrate where the first electrode is formed, and in a region outside of the sealing layer formation, the sealing portion being cured with non water-permeable sealing member that is disposed on an upper surface of the sealing portion.

8. The method of manufacturing the luminescence device according to claim 1, a plurality of the luminescence devices being concurrently formed on one substrate base material, and then the substrate base material being diced per each luminescence device.

9. A luminescence device obtained by the manufacturing method according to claim 1.
